(19) United States
(12) Patent Application Publication
(10) Pub. No.: US 2020/0280923 A1
(43) Pub. Date: Sep. 3, 2020

(54) PORTABLE ELECTRONIC DEVICE

(71) Applicant: CITIZEN WATCH CO., LTD., Nishitokyo-shi (JP)

(72) Inventors: Daisuke MATSUOH, Tokyo (JP); Ryutaro UEMURA, Tokyo (JP)

(73) Assignee: CITIZEN WATCH CO., LTD., Nishitokyo-shi (JP)

(21) Appl. No.: 16/803,240

(22) Filed: Feb. 27, 2020

(30) Foreign Application Priority Data
Feb. 28, 2019 (JP) 2019-035663
Jan. 15, 2020 (JP) 2020-004181

(51) Int. Cl. H04W 52/02; H04L 29/08; H04W 76/14; G04G 21/02; G04G 21/04; G04G 19/00

(52) U.S. Cl. CPC H04W 52/0261; H04L 67/306; G04G 19/00; G04G 21/02; G04G 21/04; H04W 76/14

(57) ABSTRACT

A portable electronic device includes: a sensor configured to detect a physical amount related to an amount of activity of a user; a communication unit configured to perform wireless communication; a controller configured to control supply of power to the sensor; and a storage unit configured to record, when pairing between the communication unit and an external device used by the user is executed, pairing information between the communication unit and the external device. A permission condition under which the controller permits the supply of power to the sensor includes a condition that pairing information is recorded in the storage unit.

### CROSS-REFERENCE TO RELATED APPLICATION(S)

The present application claims priority to and incorporates by reference the entire contents of Japanese Patent Application No. 2019-035663 filed in Japan on Feb. 28, 2019 and Japanese Patent Application No. 2020-004181 filed in Japan on Jan. 15, 2020.

### BACKGROUND OF THE INVENTION

### 1. Field of the Invention

The present invention relates to a portable electronic device.

### 2. Description of the Related Art

Conventionally, measurement terminals that calculate the amount of activity have been known. Japanese Patent No. 6049308 discloses an activity amount measurement terminal including a body motion detection unit that detects body motion of a user, a communication unit that communicates with an external device to receive personal data on the user and transmit measured or calculated data, a storage unit that stores therein the personal data on the user and the measured or calculated data, and an arithmetic unit that performs predetermined arithmetic operation based on a detection result of the body motion detection unit and the data in the storage unit.

In a portable electronic device that detects the amount of activity, it is desired to reduce power consumption. For example, in a period from when the portable electronic device is shipped until a user starts to use the portable electronic device, it is preferred to suppress power consumption in a sensor that detects a physical amount related to the amount of activity.

### SUMMARY OF THE INVENTION

It is an object of the present invention to provide a portable electronic device capable of suppressing power consumption in a sensor that detects a physical amount related to the amount of activity.

In order to solve the above mentioned problem and achieve the object, a portable electronic device according to one aspect of the present invention includes a sensor configured to detect a physical amount; a communication unit configured to perform wireless communication; a controller configured to control supply of power to the sensor; and a storage unit configured to record, when pairing between the communication unit and an external device used by a user is executed, pairing information between the communication unit and the external device, wherein a permission condition under which the controller permits the supply of power to the sensor includes a condition that the pairing information is recorded in the storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a portable electronic device according to an embodiment;

FIG. 2 is a block diagram of the portable electronic device according to the embodiment;

FIG. 3 is a diagram illustrating a first example of the flow until the supply of power to a sensor is permitted in the embodiment;

FIG. 4 is a diagram illustrating a second example of the flow until the supply of power to the sensor is permitted in the embodiment;

FIG. 5 is a diagram illustrating an acceleration sensor according to a first modification of the embodiment;

FIG. 6 is a block diagram of a portable electronic device according to a second modification of the embodiment; and

FIG. 7 is a flowchart according to the second modification of the embodiment.

### DETAILED DESCRIPTION OF THE PREFERRED EMBODIMENTS

A portable electronic device according to an embodiment of the present invention is described in detail below with reference to the drawings. The present invention is not limited by the embodiment. Components in the following embodiment include the ones that can be easily conceived by a person skilled in the art or the ones that are substantially the same.

### Embodiment

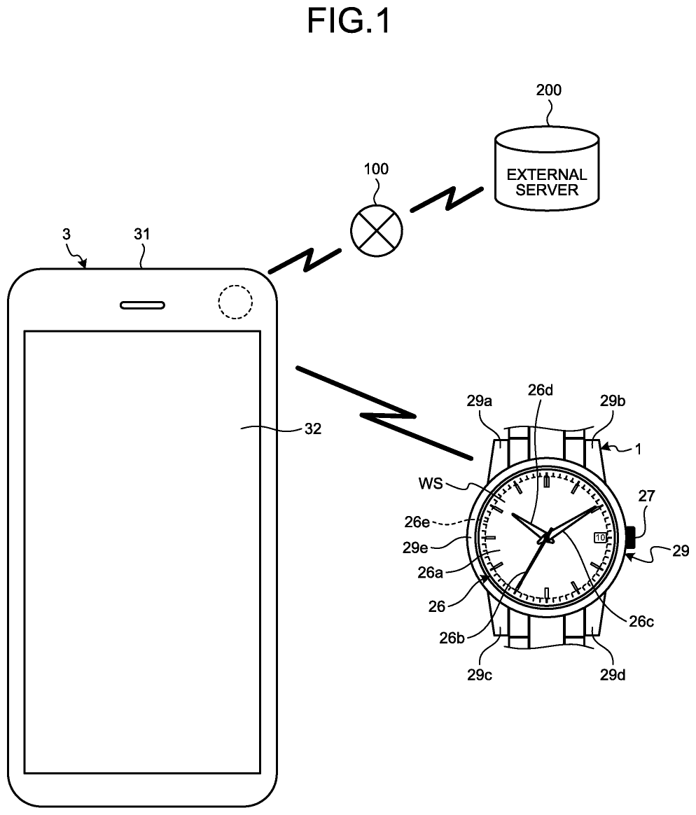

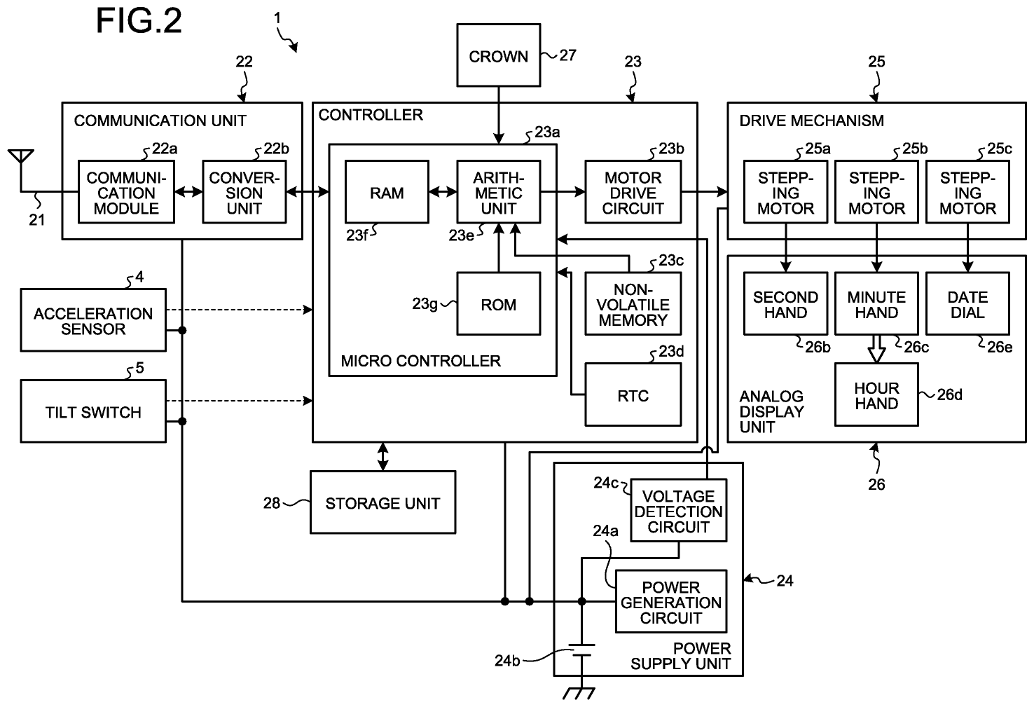

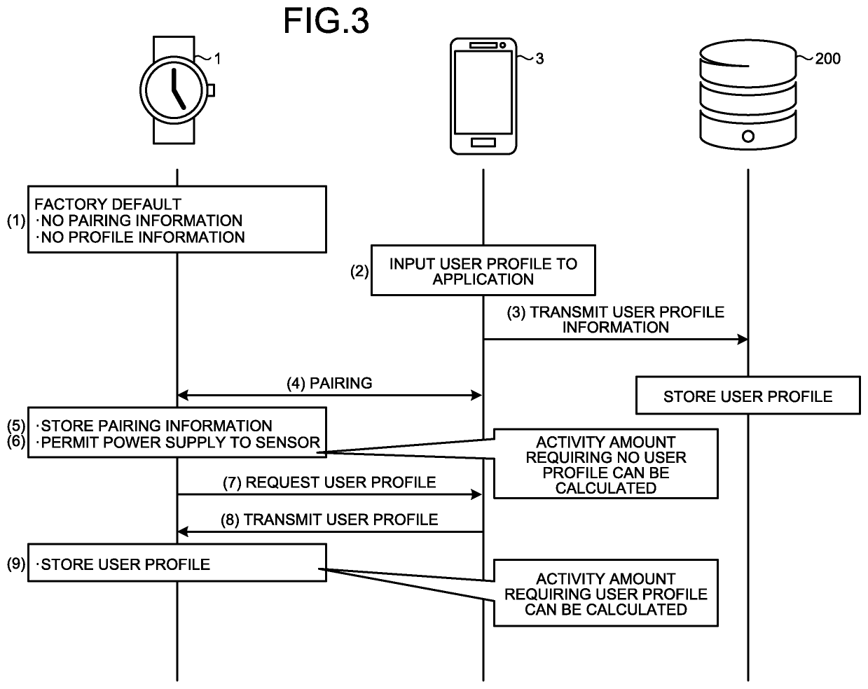

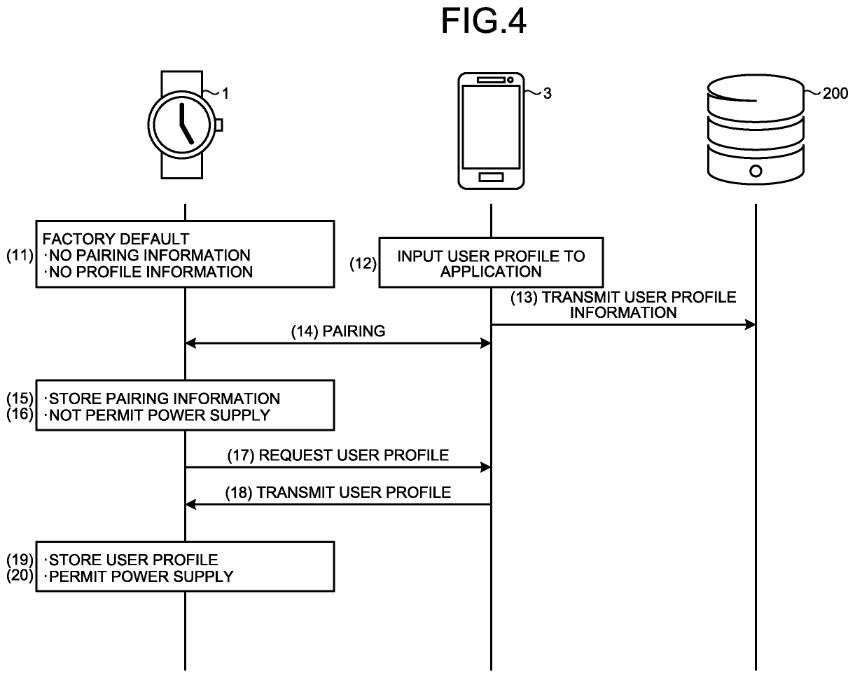

Referring to FIG. 1 to FIG. 4, an embodiment is described. The present embodiment relates to a portable electronic device. FIG. 1 is a diagram illustrating a portable electronic device according to the embodiment. FIG. 2 is a block diagram of the portable electronic device according to the embodiment. FIG. 3 is a diagram illustrating a first example of the flow until the supply of power to a sensor is permitted in the embodiment. FIG. 4 is a diagram illustrating a second example of the flow until the supply of power to the sensor is permitted in the embodiment.

An electronic watch 1 illustrated in FIG. 1 is an example of the portable electronic device according to the embodiment. The electronic watch 1 has a function for performing wireless communication with an external device 3 and a function for calculating the amount of activity of a user. As illustrated in FIG. 1, the electronic watch 1 has an analog display unit 26 and an external case 29. The external case 29 has a case main body 29e and four lugs 29a to 29d. The shape of the case main body 29e is an annular shape, and, for example, a cylinder shape. The lugs 29a to 29d protrude from the outer peripheral surface of the case main body 29e.

The analog display unit 26 is housed in an internal space in the case main body 29e. The analog display unit 26 has a dial 26a, a second hand 26b, a minute hand 26c, an hour hand 26d, and a date dial 26e. A crown 27 is disposed on the case main body 29e. An end portion of the crown 27 protrudes from the side surface of the case main body 29e.

As illustrated in FIG. 2, the electronic watch 1 further has a communication unit 22, a controller 23, a power supply unit 24, a drive mechanism 25, and a storage unit 28. The communication unit 22 has an antenna 21, a communication module 22a, and a conversion unit 22b. The antenna 21 transmits and receives radio waves of short-distance wireless communication. The antenna 21 is connected to the communication module 22a. The communication module 22a is a communication control module that performs short-distance wireless communication with the external device 3. For example, the communication module 22a communicates with the external device 3 by the protocol of Bluetooth (registered trademark). The conversion unit 22b converts a serial signal into a parallel signal, or converts a parallel signal into a serial signal.

The controller 23 controls various kinds of circuits and mechanisms in the electronic watch 1. The controller 23 has a micro controller 23a, a motor drive circuit 23b, a non-volatile memory 23c, and a real time clock (RTC) 23d. The micro controller 23a has an arithmetic unit 23e, a random access memory (RAM) 23f, and a read only memory (ROM) 23g.

The arithmetic unit 23e performs various kinds of information processing in accordance with computer programs stored in the ROM 23g. For example, the arithmetic unit 23e calculates an internal time of the electronic watch 1 based on a clock signal output from the RTC 23d. As described later, the arithmetic unit 23e in the present embodiment calculates the amount of activity of a user based on detection results of an acceleration sensor 4. The RAM 23f functions as a work memory for the arithmetic unit 23e. Information to be processed by the arithmetic unit 23e is written in the RAM 23f.

The motor drive circuit 23b controls the drive mechanism 25 based on a clock internal time. The non-volatile memory 23c is a memory that holds information when power is not supplied from the power supply unit 24 to the controller 23 or when the electronic watch 1 is restarted. For example, data on the amount of activity calculated by the arithmetic unit 23e is recorded in the non-volatile memory 23c.

The power supply unit 24 is a power source of the electronic watch 1. The power supply unit 24 supplies power to the communication unit 22, the controller 23, the drive mechanism 25, and the like. The power supply unit 24 has a power generation circuit 24a, a battery 24b, and a voltage detection circuit 24c. The power generation circuit 24a is a power generation mechanism such as a solar cell, and stores generated power in the battery 24b. The battery 24b is a rechargeable secondary battery. The voltage detection circuit 24c is a circuit that detects voltage of the battery 24b. The detection result of the voltage detection circuit 24c is output to the micro controller 23a.

The drive mechanism 25 in the present embodiment has three stepping motors 25a, 25b, and 25c. The stepping motor 25a is a motor that moves the second hand 26b. The stepping motor 25b is a motor that moves the minute hand 26c and the hour hand 26d. The stepping motor 25c is a motor that rotates the date dial 26e. The stepping motors 25a, 25b, and 25c are driven by drive signals output from the motor drive circuit 23b.

The storage unit 28 is a storage device that stores therein pairing information and user profile information. The pairing information is information on pairing between the communication unit 22 and the external device 3, and includes, for example, a pass key for pairing. Examples of the user profile information include the height and weight of the user. For example, the storage unit 28 is a non-volatile memory such as a flash memory and an EEPROM.

The electronic watch 1 in the present embodiment has the acceleration sensor 4 and a tilt switch 5. The acceleration sensor 4 is a sensor that detects acceleration of the electronic watch 1. For example, the acceleration sensor 4 detects three-dimensional acceleration of the electronic watch 1. The acceleration sensor 4 outputs a signal of amplitude corresponding to the magnitude of the detected acceleration. For example, the amplitude of the signal output from the acceleration sensor 4 becomes larger as the absolute value of the detected acceleration becomes larger.

The tilt switch 5 is a sensor that detects a change in posture of the electronic watch 1. The tilt switch 5 switches from the on state to the off state or from the off state to the on state depending on a change in tilt angle of the electronic watch 1. The detection results of the acceleration sensor 4 and the tilt switch 5 are output to the controller 23. The acceleration sensor 4 and the tilt switch 5 operate by power supplied from the power supply unit 24.

The external device 3 illustrated in FIG. 1 is a device owned by a user of the electronic watch 1, and used by the user. The external device 3 is typically a portable terminal device such as a smartphone. The external device 3 has a function for executing short-distance wireless communication. The external device 3 has a function for communicating with an external server 200 through an Internet network 100. The external device 3 has a casing 31 and a touch panel 32. The touch panel 32 is overlapped on an image display surface. The user can operate the external device 3 through input operation on the touch panel 32.

To perform wireless communication between the electronic watch 1 and the external device 3 for the first time, the user pairs the electronic watch 1 with the external device 3. After pairing is executed, the electronic watch 1 and the external device 3 can automatically start wireless communication. To pair the electronic watch 1 with the external device 3, the user performs pairing start operation on the electronic watch 1. For example, the pairing start operation is predetermined operation on the crown 27. The user performs pairing start operation on the external device 3. For example, the pairing start operation on the external device 3 is performed through the touch panel 32.

The external device 3 in the embodiment can execute an activity amount management application. The activity amount management application is an application for storing and managing the amount of activity of the user calculated by the electronic watch 1. The external device 3 acquires activity amount data on the user from the electronic watch 1 by wireless communication. Pairing in the external device 3 may be executed by the activity amount management application.

When the pairing start operation is performed by the user, the controller 23 in the electronic watch 1 controls the communication unit 22 to execute pairing operation. The communication unit 22 performs pairing with the external device 3 along a predetermined procedure. For example, the communication unit 22 uses an authentication code to perform pairing authentication operation, and establishes a communication link with the external device 3.

For example, after pairing authentication, the communication unit 22 forms a common code (for example, link key) to form a communication link. When the communication link with the external device 3 is formed, the communication unit 22 notifies the controller 23 of the completion of the pairing.

The controller 23 that has been notified of pairing completion acquires pairing information between the communication unit 22 and the external device 3 from the communication unit 22. Examples of the pairing information include identification information on the external device 3 and a link key. The controller 23 records the acquired pairing information in the storage unit 28. A communication link between the communication unit 22 and the external device 3 for the next time is formed based on the pairing information recorded in the storage unit 28. In other words, as long as the pairing information is recorded in the storage unit 28, the communication unit 22 can form a communication link with the external device 3 and start communication. When a communication link has not been formed between the communication unit 22 and the external device 3, the controller 23 controls the communication unit 22 to form a communication link with the external device 3 based on the pairing information recorded in the storage unit 28. When the formation of the communication link has failed, the controller 23 tries to form a communication link periodically until the formation of the communication is successful.

The supply of power from the battery 24b to the acceleration sensor 4 is controlled by the controller 23. The controller 23 can further control the supply of power from the battery 24b to the tilt switch 5.

The controller 23 in the present embodiment calculates the amount of activity of the user based on the detection result of the acceleration sensor 4. Examples of the amount of activity of the user include the walk count of the user and calorie consumption of the user. Of the amounts of activity, the calorie consumption is calculated based on profile information on the user in addition to the detection result of the acceleration sensor 4. The profile information on the user includes the height and the weight of the user. On the other hand, the walk count of the user can be calculated without referring to the profile information. The electronic watch 1 in the present embodiment is configured such that profile information on the user is acquired by wireless communication from the external device 3. The electronic watch 1 records the acquired profile information in the storage unit 28, and calculates the amount of activity of the user based on the acquired profile information. Thus, the electronic watch 1 cannot calculate the amount of activity requiring the profile information until the profile information is acquired from the external device 3.

As described below, the electronic watch 1 in the present embodiment permits the supply of power to the acceleration sensor 4 when a predetermined permission condition is satisfied. In this manner, the electronic watch 1 in the present embodiment can suppress the supply of unnecessary power to the acceleration sensor 4, and reduce power consumption by the acceleration sensor 4.

The permission conditions in the present embodiment include a condition that pairing information with the external device 3 is recorded in the storage unit 28. In other words, the controller 23 permits the supply of power to the acceleration sensor 4 under a permission condition that pairing between the electronic watch 1 and the external device 3 has been made. In this manner, for example, the power consumption in the acceleration sensor 4 is suppressed from when the electronic watch 1 is shipped until the user starts using the electronic watch 1.

The permission conditions in the present embodiment include a condition that profile information on the user is recorded in the storage unit 28. In other words, the controller 23 permits the supply of power to the acceleration sensor 4 under a permission condition that the profile information on the user has been acquired. In this manner, for example, the power consumption in the acceleration sensor 4 is suppressed until the electronic watch 1 can appropriately calculate the amount of activity.

Referring to FIG. 3, an example of the flow until the supply of power to the acceleration sensor 4 is permitted is described.

(1) The electronic watch 1 in factory default does not have pairing information and profile information. In other words, in factory shipping, pairing information and user profile information are not recorded in the storage unit 28.
(2) The user inputs user profile information through an application on the external device 3. In the example in FIG. 3, profile information is input before pairing is executed.
(3) The application on the external device 3 transmits the profile information to the external server 200. The external server 200 stores the received profile information in a storage device or the like.
(4) When communicating the electronic watch 1 with the external device 3 for the first time, the user performs pairing start operation on the electronic watch 1 and the external device 3 to execute pairing.
(5) The controller 23 records pairing information in the storage unit 28.
(6) When the pairing information is recorded in the storage unit 28, the controller 23 permits the supply of power to the acceleration sensor 4. When power is supplied to the acceleration sensor 4, the amount of activity that does not require a user profile can be calculated.
(7) When the electronic watch 1 forms a communication link with the external device 3 based on the pairing information, the electronic watch 1 requests the external device 3 for profile information.
(8) The external device 3 transmits the profile information to the electronic watch 1.
(9) The electronic watch 1 records the received profile information in the storage unit 28. When the profile information is acquired, the amount of activity requiring the user profile can be calculated.

The electronic watch 1 in the present embodiment performs the above-mentioned power supply control, and can suppress unnecessary power consumption in the electronic watch 1. For example, in the electronic watch 1 in factory default, neither of pairing information and profile information is recorded in the storage unit 28. Thus, the controller 23 does not permit the supply of power to the acceleration sensor 4. As a result, power consumption by the acceleration sensor 4 is suppressed, and power consumption in the electronic watch 1 is reduced.

In factory default, the acceleration sensor 4 is prevented from operating, and hence unnecessary activity amount data is not calculated. For example, if the acceleration sensor 4 operates in a period from when the electronic watch 1 is shipped until the electronic watch 1 is delivered to a user, activity amount data irrelevant to the user is generated and accumulated in the electronic watch 1. Furthermore, if the electronic watch 1 and the external device 3 are paired, the stored unnecessary activity amount data is transmitted to the external device 3. On the other hand, in the electronic watch 1 in the present embodiment, unnecessary activity amount data is not generated.

Before the electronic watch 1 is shipped, factory inspection is performed for the acceleration sensor 4. In the factory inspection, as described below, the supply of power to the acceleration sensor 4 is temporarily permitted. When the factory inspection is executed, the mode of the electronic watch 1 is set to a test mode. In the test mode, the supply of power to the acceleration sensor 4 is permitted even when pairing information or profile information is not recorded in the storage unit 28. In the case where a sensor that detects a physical amount related to the amount of activity of the user other than the acceleration sensor 4 is mounted on the electronic watch 1, the supply of power to the sensor is similarly permitted such that inspection can be performed.

When factory inspection is performed, pairing information and profile information for inspection may be recorded in the storage unit 28. When the pairing information and profile information for inspection are recorded, the supply of power to the acceleration sensor 4 is permitted. In the case where a sensor that detects a physical amount related to the amount of activity of the user other than the acceleration sensor 4 is mounted on the electronic watch 1, the supply of power to the sensor is similarly permitted such that inspection can be performed. After the factory inspection is completed, the pairing information and profile information for inspection are erased from the storage unit 28.

In the example in FIG. 3, the user profile is input before pairing is executed. However, the profile information is not necessarily required to be input before pairing is executed. The user may perform processing for registering and storing a user profile in the electronic watch 1 when it is necessary to calculate the amount of activity requiring the user profile.

Referring to FIG. 4, a second example of the flow until the supply of power to the acceleration sensor 4 is permitted is described. The second example illustrated in FIG. 4 is different from the first example illustrated in FIG. 3 in that, for example, the supply of power to the acceleration sensor 4 is permitted after both pairing information and profile information are recorded.

(11) In factory default, neither of pairing information and profile information is recorded.
(12) The user inputs user profile information through an application on the external device 3. Also in the example in FIG. 4, the profile information is input before pairing is executed.
(13) The external device 3 transmits profile information to the external server 200.
(14) Pairing by the user is performed.
(15) The controller 23 records the pairing information in the storage unit 28.
(16) In the storage unit 28, the pairing information is recorded, but profile information is not recorded. Thus, the controller 23 does not allow the supply of power to the acceleration sensor 4.
(17) The electronic watch 1 requests the external device 3 for profile information.
(18) The external device 3 transmits the profile information to the electronic watch 1.
(19) The electronic watch 1 records the received profile information in the storage unit 28.
(20) When the profile information is recorded in the storage unit 28, the electronic watch 1 permits the supply of power to the acceleration sensor 4.

In this manner, the supply of power to the acceleration sensor 4 is not permitted until the user profile information is acquired, and hence power consumption in the electronic watch 1 is reduced. In other words, the electronic watch 1 in the present embodiment permits the supply of power to the acceleration sensor 4 after activity amount data using profile information can be calculated, thus reducing power consumption. For example, when calculating calorie consumption of the user as activity amount data, profile information such as the height and the weight is necessary. According to the present embodiment, the acceleration sensor 4 is prevented from being operated while information necessary for calculating activity amount data is insufficient.

In the electronic watch 1 in the present embodiment, the pairing information with the external device 3 can be erased. The pairing information is erased by operation by the user. Examples of the operation to erase the pairing information include predetermined operation on the crown 27. When the operation to erase pairing information is performed by the user, the controller 23 in the present embodiment erases profile information together with pairing information from the storage unit 28. In this manner, in the storage unit 28, neither of the pairing information and the profile information is recorded. When the pairing information and the profile information are erased from the storage unit 28, the controller 23 prohibits the supply of power to the acceleration sensor 4 until at least pairing information is recorded in the storage unit 28 next time. The controller 23 may prohibit the supply of power to the acceleration sensor 4 until both of pairing information and profile information are recorded.

When the state in which the amplitude of a signal output from the acceleration sensor 4 is lower than a predetermined value continues for a predetermined period, the controller 23 in the present embodiment stops the supply of power to the acceleration sensor 4. For example, the above-mentioned predetermined value is determined based on an upper limit value of the amplitude of the signal output from the acceleration sensor 4 when the electronic watch 1 is not used. Alternatively, the above-mentioned predetermined value is determined based on an upper limit value of the amplitude of a signal output from the acceleration sensor 4 when the user wearing the electronic watch 1 is stationary. In other words, the controller 23 stops the supply of power to the acceleration sensor 4 when the state in which the electronic watch 1 is not in use continues for a predetermined period or when the state in which the user is substantially stationary continues for a predetermined period. In this manner, the controller 23 can reduce power consumption in the electronic watch 1.

The controller 23 in the embodiment operates the tilt switch 5 when the supply of power to the acceleration sensor 4 is stopped. When determining that the posture of the electronic watch 1 has changed based on a detection result of the tilt switch 5, the controller 23 restarts the supply of power to the acceleration sensor 4. The acceleration sensor 4 consumes a larger amount of power than the tilt switch 5. Thus, the electronic watch 1 in the present embodiment can reduce power consumption in the electronic watch 1 by minimizing the supply of power to the acceleration sensor 4.

As described above, the electronic watch 1 in the embodiment has the acceleration sensor 4, the communication unit 22, the controller 23, the storage unit 28, and the arithmetic unit 23e. The electronic watch 1 is an example of a portable electronic device. The acceleration sensor 4 is an example of a sensor that detects physical amount on the amount of activity of a user. The communication unit 22 is a circuit that performs wireless communication. The controller 23 is a control circuit that controls the supply of power to the acceleration sensor 4. In the storage unit 28, pairing information between the communication unit 22 and the external device 3 is recorded when pairing is executed between the communication unit 22 and the external device 3. The arithmetic unit 23e is an example of a calculation unit that calculates the amount of activity of the user based on a detection result of the acceleration sensor 4.

The permission condition under which the controller 23 in the present embodiment permits the supply of power to the acceleration sensor 4 includes a condition that pairing information is recorded in the storage unit 28. In the electronic watch 1 in the present embodiment, the supply of power to the acceleration sensor 4 is not permitted when pairing information is not recorded in the storage unit 28, and hence power consumption in the acceleration sensor 4 is suppressed.

In the electronic watch 1 in the present embodiment, when profile information on a user is acquired by wireless communication between the communication unit 22 and the external device 3, the profile information is recorded in the storage unit 28. The permission condition for permitting the supply of power to the acceleration sensor 4 may include a condition that the profile information is recorded in the storage unit 28. In this case, the supply of power to the acceleration sensor 4 is not permitted when profile information is not recorded, and hence power consumption in the acceleration sensor 4 is further suppressed.

### First Modification of Embodiment

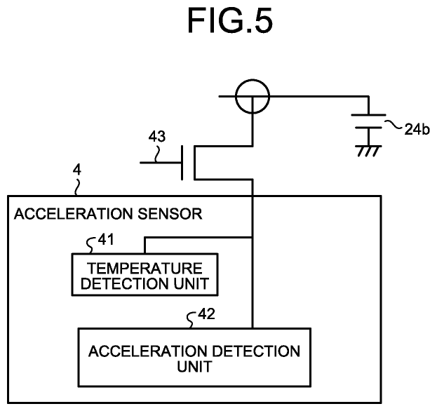

A first modification of the embodiment is described. FIG. 5 is a diagram illustrating an acceleration sensor according to the first modification of the embodiment. The first modification of the embodiment is different from the above-mentioned embodiment in that, for example, the acceleration sensor 4 includes a temperature detection unit 41. As illustrated in FIG. 5, the acceleration sensor 4 according to the first modification of the embodiment has a temperature detection unit 41 and an acceleration detection unit 42. The temperature detection unit 41 is a circuit that detects temperature. The acceleration detection unit 42 is a circuit that detects acceleration, and detects, for example, acceleration in three orthogonal axis directions. For example, detection results of the temperature detection unit 41 and the acceleration detection unit 42 are output to the controller 23.

In the acceleration sensor 4, a power supply line for the temperature detection unit 41 and a power supply line for the acceleration sensor 4 are shared. In other words, the acceleration sensor 4 is configured such that when power is supplied to the temperature detection unit 41, power is also supplied to the acceleration detection unit 42. The supply of power to the acceleration sensor 4 is controlled by a control IC 43. The control IC 43 operates in response to an instruction from the controller 23.

The controller 23 according to the first modification of the embodiment supplies power to the acceleration sensor 4 based on a sampling interval of the temperature detection unit 41. For example, the sampling interval of the temperature detection unit 41 is 5 minutes. In this case, the controller 23 supplies power to the acceleration sensor 4 for every 5 minutes, so that temperature is detected by the temperature detection unit 41. When power is supplied to the acceleration sensor 4, the controller 23 may prevent the acceleration detection unit 42 from detecting acceleration. When the detection result is output from the temperature detection unit 41, the controller 23 stops the supply of power to the acceleration sensor 4. In other words, the controller 23 prohibits the supply of power to the acceleration sensor 4 in periods other than the period during which temperature is detected by the temperature detection unit 41.

According to the first modification, the supply of power to the acceleration sensor 4 is permitted in a limited period necessary for temperature detection. Thus, the period during which power is supplied to the acceleration sensor 4 can be minimized to reduce power consumption in the electronic watch 1.

### Second Modification of Embodiment

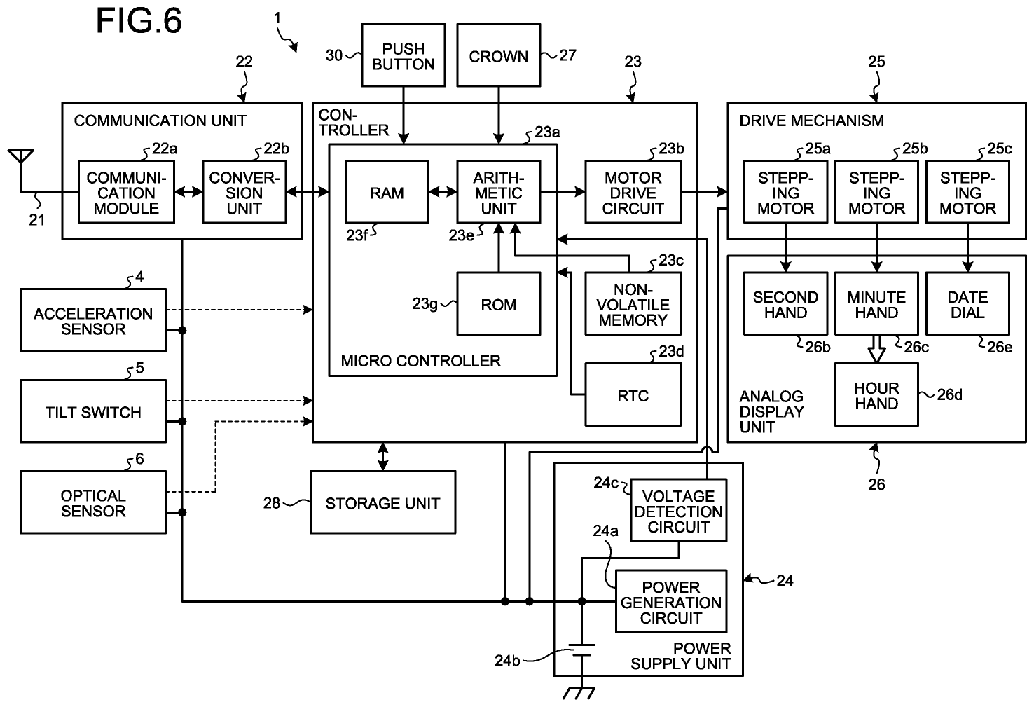

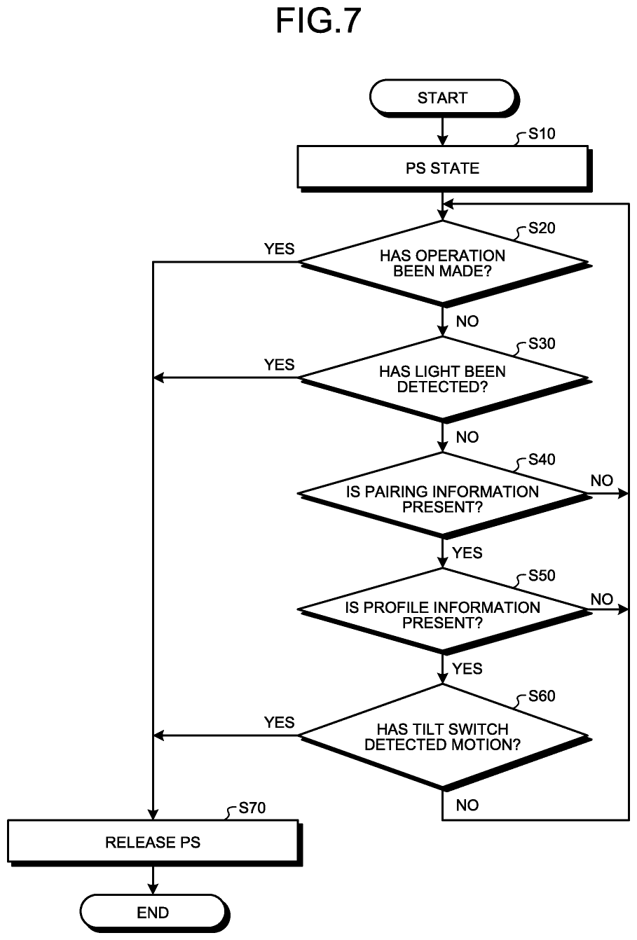

A second modification of the embodiment is described. FIG. 6 is a block diagram of a portable electronic device according to a second modification of the embodiment. FIG. 7 is a flowchart according to the second modification of the embodiment. The second modification of the embodiment is different from the above-mentioned embodiment in that, for example, whether to recover from the power-saving mode is determined based on the presence/absence of pairing information or the presence/absence of profile information.

As illustrated in FIG. 6, an electronic watch 1 according to the second modification has a push button 30 and an optical sensor 6. For example, the push button 30 is disposed adjacent to the crown 27. The electronic watch 1 is configured to perform various kinds of processing and setting in response to operation on the push button 30. A signal indicating operation on the push button 30 is output to the controller 23. For example, the optical sensor 6 is disposed on the rear surface side of the dial 26a. For example, the optical sensor 6 is a light receiving element that outputs a signal corresponding to the amount of received light. A signal indicating the detection result of the optical sensor 6 is output to the controller 23.

The electronic watch 1 has a power-saving mode (PS state). The power-saving mode is a mode for suppressing power consumption in the electronic watch 1. In the power-saving mode, the handling of at least one of the second hand 26b, the minute hand 26c, and the hour hand 26d is stopped. In the power-saving mode, for example, the handling of the second hand 26b is stopped, and the handling of the minute hand 26c and the hour hand 26d is executed. The controller 23 is configured to execute the shift determination to the power-saving mode and the recovery determination from the power-saving mode.

For example, the controller 23 shifts the electronic watch 1 to the power-saving mode when a predetermined shift condition is satisfied. For example, the shift condition is a condition that the amount of received light of the optical sensor 6 is equal to or smaller than a lower limit value.

Referring to FIG. 7, the shift to the power-saving mode and the recovery from the power-saving mode are described. When the shift condition is satisfied, the controller 23 executes control based on the flowchart illustrated in FIG. 7. At Step S10, the controller 23 instructs the motor drive circuit 23b to shift to the power-saving mode. In response to the instruction to shift to the power-saving mode, the motor drive circuit 23b executes the handling control in the power-saving mode. In the handling control in the power-saving mode, for example, the handling of the second hand 26b is stopped. For example, the motor drive circuit 23b stops the second hand 26b at the position of the hour. In the handling control in the power-saving mode, the motor drive circuit 23b may handle the minute hand 26c and the hour hand 26d in accordance with the internal time, and may stop the minute hand 26c and the hour hand 26d. After Step S10 is executed, the flow proceeds to Step S20.

At Step S20, the controller 23 determines whether operation by the user has been made. For example, the controller 23 determines whether operation on the crown 27 or the push button 30 has been detected. The flow proceeds to Step S70 when positive determination that the user operation has been performed is made at Step S20, and the flow proceeds to Step S30 when negative determination is made.

At Step S30, the controller 23 determines whether light has been detected. The controller 23 performs the determination at Step S30 based on the detection result of the optical sensor 6. For example, the controller 23 makes positive determination at Step S30, for example, when the amount of received light of the optical sensor 6 is equal to or more than a threshold. For example, the threshold is determined such that the amount of power generated by the power generation circuit 24a exceeds a predetermined lower limit value. As a result of the determination at Step S30, when positive determination that light has been detected is made, the flow proceeds to Step S70, and when negative determination is made, the flow proceeds to Step S40.

At Step S40, the controller 23 determines whether pairing information is present. The controller 23 makes positive determination at Step S40 when pairing information is recorded in the storage unit 28. As a result of the determination at Step S40, when positive determination that pairing information is present is made, the flow proceeds to Step S50, and when negative determination is made, the flow proceeds to Step S20.

At Step S50, the controller 23 determines whether profile information is present. The controller 23 makes positive determination at Step S50 when profile information is recorded in the storage unit 28. As a result of the determination at Step S50, when positive determination that profile information is present is made, the flow proceeds to Step S60, and when negative determination is made, the flow proceeds to Step S20.

At Step S60, the controller 23 determines whether the tilt switch 5 has detected motion. For example, the controller 23 makes positive determination at Step S60 when the state of the tilt switch 5 has been switched from the on state to the off state or from the off state to the on state. As a result of the determination at Step S60, when positive determination that the tilt switch 5 has detected motion is made, the flow proceeds to Step S70, and when negative determination is made, the flow proceeds to Step S20.

At Step S70, the controller 23 releases the PS state of the electronic watch 1. The controller 23 instructs the motor drive circuit 23b to recover from the power-saving mode to a normal handling mode. In response to the recovery instruction, the motor drive circuit 23b executes handling control in the normal handling mode. In the handling control in the normal handling mode, the motor drive circuit 23b handles all the second hand 26b, the minute hand 26c, and the hour hand 26d in accordance with the internal time. After Step S70 is executed, this control flow is finished.

As described above, the controller 23 according to the second modification of the embodiment permits the recovery from the power-saving mode when a recovery condition is satisfied during the execution of the power-saving mode. The recovery condition includes a condition that pairing information is recorded in the storage unit 28 (S40—Y) and a condition that the tilt switch 5 has detected a change in tilt angle (S60—Y). The recovery from the power-saving mode is not permitted when pairing information is not recorded in the storage unit 28, and hence power consumption in the electronic watch 1 is suppressed. For example, in the period from when the electronic watch 1 is shipped until the user executes pairing on the electronic watch 1, the recovery from the power-saving mode is not permitted even when the tilt switch 5 detects the motion of the electronic watch 1. In other words, even when the state of the tilt switch 5 is switched during transport, the power-saving mode is maintained and power consumption is suppressed.

The recovery condition includes a condition that profile information is recorded in the storage unit 28. The recovery from the power-saving mode is not permitted when pairing information is not recorded in the storage unit 28, and hence power consumption in the electronic watch 1 is suppressed.

In the flowchart in FIG. 7, Step S40 or Step S50 may be omitted. For example, in the case where Step S40 is omitted, irrespective of whether pairing information is present, the recovery from the power-saving mode is permitted when profile information is present and when the tilt switch 5 has detected the motion of the electronic watch 1. For example, in the case where Step S50 is omitted, irrespective of whether profile information is present, the recovery from the power-saving mode is permitted when pairing information is present and when the tilt switch 5 has detected the motion of the electronic watch 1.

### Third Modification of Embodiment

Means for the electronic watch 1 to acquire the profile of a user is not limited to communication with the external device 3. For example, profile information may be directly input to the electronic watch 1 by operation on an operation member provided to the electronic watch 1. For example, the operation member that receives profile information may be a push button. When profile information is input by operation on the operation member, the electronic watch 1 records the profile information in the storage unit 28. In this case, the electronic watch 1 can permit the supply of power to the acceleration sensor 4 at a time when necessary profile information is recorded in the storage unit 28.

When operation to erase pairing information is performed by the user, the controller 23 may erase the pairing information and leave profile information without erasing the profile information. In this manner, when the user has changed the device model of the external device 3, the user can change pairing information while the profile information is left in the storage unit 28.

The permission condition is not necessarily required to include a condition that the profile information is recorded in the storage unit 28. In other words, the controller 23 may permit the supply of power to the acceleration sensor 4 as long as pairing information is recorded in the storage unit 28 irrespective of whether profile information is recorded in the storage unit 28.

The electronic watch 1 may be configured such that a user can prohibit the supply of power to the acceleration sensor 4. In this case, for example, the supply of power to the acceleration sensor 4 may be stopped by operation by the user on the crown 27 or a push button. Alternatively, an instruction to stop the supply of power to the acceleration sensor 4 may be transmitted by wireless communication between the external device 3 and the electronic watch 1. In this case, for example, the user stops the supply of power to the acceleration sensor 4 by operating an application on the external device 3. In this manner, wasted power consumption in the electronic watch 1 can be reduced in a situation where the user does not need information from the acceleration sensor 4.

The portable electronic devices in the above-mentioned embodiment and modifications are not limited to the exemplified electronic watches 1. For example, the portable electronic device is not limited to an analog electronic watch that displays time by hands, and may be an electronic watch that displays time by digital display. The portable electronic device may be what is called smart watch. The portable electronic device is preferably a wristwatch type device, but may be a device other than the wristwatch type device.

The sensor that detects the amount of activity of a user is not limited to the acceleration sensor 4, and may be, for example, a sensor that detects human body information such as a heartbeat sensor. The electronic watch 1 may have a position detection sensor such as a GPS and a sensor that detects ambient environments such as an ambient environment temperature sensor. The controller 23 may calculate the amount of activity of the user by using detection results of the position detection sensor and the sensor that detects ambient environments. The amount of activity of the user may be calculated in the external device 3, or may be calculated by the external server 200.

The contents disclosed in the above-mentioned embodiment and modifications can be executed in combination as appropriate.

The portable electronic device according to the embodiment includes: the sensor configured to detect a physical amount related to an amount of activity of a user; the communication unit configured to perform wireless communication; the controller configured to control supply of power to the sensor; the storage unit configured to record, when pairing between the communication unit and an external device used by the user is executed, pairing information between the communication unit and the external device; and the calculation unit that calculates the amount of activity of the user based on a detection result of the sensor. The permission condition under which the controller permits the supply of power to the sensor includes a condition that the pairing information is recorded in the storage unit. The portable electronic device according to the embodiment exhibits an effect that the supply of power to a sensor that detects the amount of activity is not permitted when pairing information is not recorded in the storage unit, and hence power consumption in the sensor can be suppressed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A portable electronic device, comprising:
a sensor configured to detect a physical amount;
a communication unit configured to perform wireless communication;
a controller configured to control supply of power to the sensor; and
a storage unit configured to record, when pairing between the communication unit and an external device used by a user is executed, pairing information between the communication unit and the external device, wherein
a permission condition under which the controller permits the supply of power to the sensor includes a condition that the pairing information is recorded in the storage unit.

2. The portable electronic device according to claim 1, wherein
when profile information on the user is acquired by wireless communication between the communication unit and the external device, the profile information is recorded in the storage unit, and
the permission condition includes a condition that the profile information is recorded in the storage unit.

3. The portable electronic device according to claim 2, wherein,
when operation to erase the pairing information is performed by the user, the pairing information and the profile information are erased from the storage unit.

4. The portable electronic device according to claim 3, wherein
the supply of power to the sensor is prohibited until at least the pairing information is recorded in the storage unit next time.

5. The portable electronic device according to claim 1, wherein
the sensor is an acceleration sensor that outputs a signal of amplitude corresponding to magnitude of acceleration, and
the controller stops the supply of power to the sensor when a state in which the amplitude of the signal output from the sensor is smaller than a predetermined value continues for a predetermined period.

6. The portable electronic device according to claim 1, further comprising:
a tilt switch that switches between an on state and an off state in accordance with a tilt angle, wherein
the controller permits recovery from a power-saving mode when a recovery condition is satisfied during execution of the power-saving mode, and
the recovery condition includes a condition that the pairing information is recorded in the storage unit and a condition that the tilt switch has detected a change in the tilt angle.

7. The portable electronic device according to claim 6, wherein
when profile information on the user is acquired by wireless communication between the communication unit and the external device, the profile information is recorded in the storage unit, and
the recovery condition includes a condition that the profile information is recorded in the storage unit.

8. The portable electronic device according to claim 1, wherein
the portable electronic device is a wristwatch type device.
